(19) United States
(12) Patent Application Publication
(10) Pub. No.: US 2017/0217662 A1
(43) Pub. Date: Aug. 3, 2017

(54) Microwave Heating Construct

(71) Applicant: Graphic Packaging International, Inc., Atlanta, GA (US)

(72) Inventors: Dana Lauren Pearson, Lyons, CO (US); Fermin P. Resurreccion, JR., Thornton, CO (US); Paul Abbott, Louisville, CO (US); Vladimir C. Martinez, Aurora, CO (US); Michael L. Schlauch, Boulder, CO (US); William Gilpatrick, Broomfield, CO (US)

(21) Appl. No.: 15/419,089

(22) Filed: Jan. 30, 2017

Related U.S. Application Data
(60) Provisional application No. 62/289,571, filed on Feb. 1, 2016.

(51) Int. Cl. B65D 81/34; B65D 77/22; B65D 81/26; B65D 77/20; A23L 5/10; B65D 1/34

(52) U.S. Cl. CPC B65D 81/3453; A23L 5/15; B65D 1/34; B65D 81/264; B65D 77/20; B65D 77/22; A23V 2002/00

(57) ABSTRACT

A microwave heating construct that includes a bottom and upstanding side walls formed from a first pair of opposing side walls and a second pair of opposing side walls. The first pair of opposing side walls being substantially parallel and the second pair of opposing side walls being substantially parallel. The first pair of opposing side walls being connected to the second pair of opposing side walls along corners to form a continuous upper surface above the bottom. The construct includes at least one raised surface disposed above the bottom with the at least one raised surface being defined by an upper surface that slopes downwardly to the bottom. The construct can be packaged with a pad and a product to be heated under a film.

### CROSS REFERENCE TO RELATED APPLICATION

This application claims the benefit of U.S. Provisional Patent Application No. 62/289,571, filed Feb. 1, 2016.

### INCORPORATION BY REFERENCE

The disclosure of U.S. Provisional Patent Application No. 62/289,571, which was filed Feb. 1, 2016, is hereby incorporated by reference for all purposes as if presented herein in its entirety.

### BACKGROUND

Typical stovetop cooking of certain types of meat, such as bacon, is a cumbersome, time consuming process—often involving hot popping grease, long cook times, and heavy clean up. However, cooked meat, especially bacon, is a popular addition to any meal and is a favorite for consumers.

### SUMMARY

In one aspect, the present disclosure relates to a cooking device to heat raw or partially cooked meat, such as bacon, effectively in a microwave while yielding a consistent cooking, proper crisping, and successful grease mitigation. In one aspect, the present disclosure includes a microwave heating construct comprising a bottom and upstanding side walls that include at least a first pair of opposing side walls and a second set of opposing side walls with the first pair of opposing side walls being substantially parallel and the second pair of opposing side walls being substantially parallel. The first pair of opposing side walls being connected to the second pair of opposing side walls along corners to form a continuous upper surface above the bottom. The construct of the present disclosure can also include at least one raised surface with the raised surface being disposed above the bottom, with the raised surfaces being defined by an upper surface that slopes downwardly to the bottom. The present disclosure can also utilize a wicking insert and can include paperboard embossing that allows grease to be contained at prescribed locations and to be distributed evenly across the bottom. The insert acts as a microwave absorber for proper cooking while also protecting the consumer from being burned or burdened with any post cook clean up.

In one aspect, the present disclosure involves a cooking device that: (1) uses an absorbent wicking insert underneath the meat and tray embossing to evenly distribute grease for consistent cooking of raw or partially cooked meat, such as bacon, and mitigate grease for an essentially “no-mess” clean up, (2) migrates grease and salt to the wicking insert at the later part of the cooking process to make the insert relatively lossy which will then subsequently become a microwave absorber improving cooking through conventional conductive heating, (3) utilizes a vacuum sealed film that tightly hugs the product to prevent excessive volume shrinkage or curling, and (4) allows for adults and young children to make cooked meat quickly and safely with a short microwave cook time and grease containment system to avoid grease spilling and burning.

In another aspect, the present disclosure can include: (1) an insert with grease wicking and absorbance capabilities that is permeable to byproducts of cooked meat, such as bacon grease and salt. When saturated, the wicking material exhibits susceptor-like qualities by absorbing microwave energy and heating the meat conductively from the bottom—for bacon, for example, this bottom heating together with volumetric heating from the top results in relatively uniform heating and crisping of the bacon similar to pan frying, (2) bacon maintains integrity during cooking with less size reduction post cooking than in conventional microwaveable bacon products, and (3) a “no-mess” embossing feature that allows grease to drain away from the food product thereby essentially eliminating grease spills or burns.

The foregoing presents a simplified summary of some aspects of this disclosure in order to provide a basic understanding. The foregoing summary is not an extensive summary of the disclosure and is not intended to identify key or critical elements of the disclosure or to delineate the scope of the disclosure. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

Having described some aspects of this disclosure in general terms, reference will now be made to the accompanying drawings, which are schematic and not necessarily drawn to scale. The drawings are exemplary only, and should not be construed as limiting the disclosure.

FIGS. 1A through 1D show a first embodiment of a heating construct according to one aspect of the disclosure.

FIG. 2 shows the bottom view of the heating construct of the first embodiment.

FIG. 3 shows the heating construct of the first embodiment with four slices of bacon and a covering.

FIG. 4 shows the heating construct of FIG. 3 after heating and with the covering removed.

FIGS. 5A through 5D show a second embodiment of a heating construct according to one aspect of the disclosure.

FIG. 6A shows a first alternate embodiment tray design without embossing or pattern.

FIG. 6B shows a second alternate embodiment tray design with raised hills or dots.

FIG. 6C shows a third alternate embodiment tray design with raised lines that form sections for individual product slices.

### DETAILED DESCRIPTION

Various features, advantages and aspects of the present disclosure may be set forth or apparent from consideration of the following detailed description, when taken in conjunction with the accompanying drawings. Moreover, it will be understood that the accompanying drawings, which are included to provide a further understanding of the present disclosure, are incorporated in and constitute a part of this specification, illustrate various aspects, advantages and benefits of the present disclosure, and together with the detailed description, serve to explain the principles of the present disclosure. In addition, those skilled in the art will understand that, according to common practice, various features of the drawings discussed below are not necessarily drawn to scale, and that dimensions of various features and elements of the drawings may be expanded or reduced to more clearly illustrate the embodiments of the present disclosure.

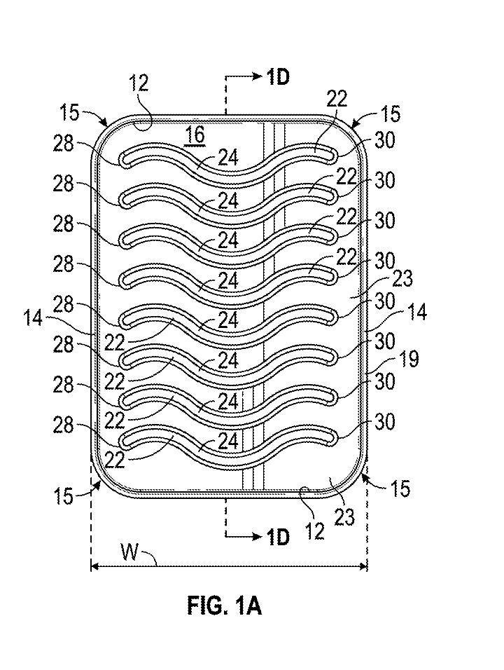

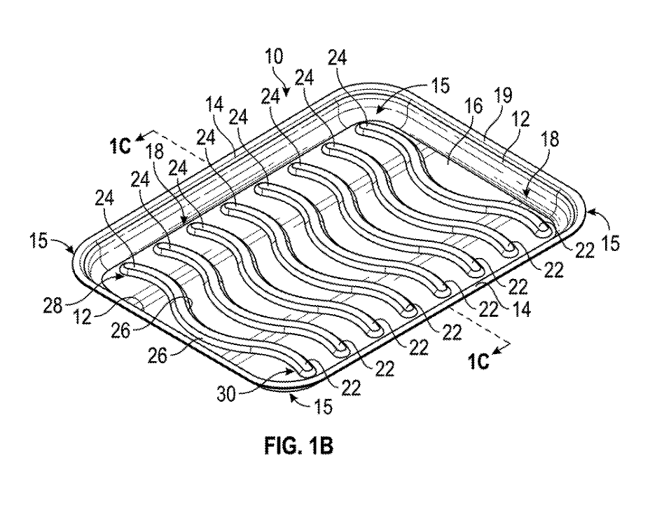

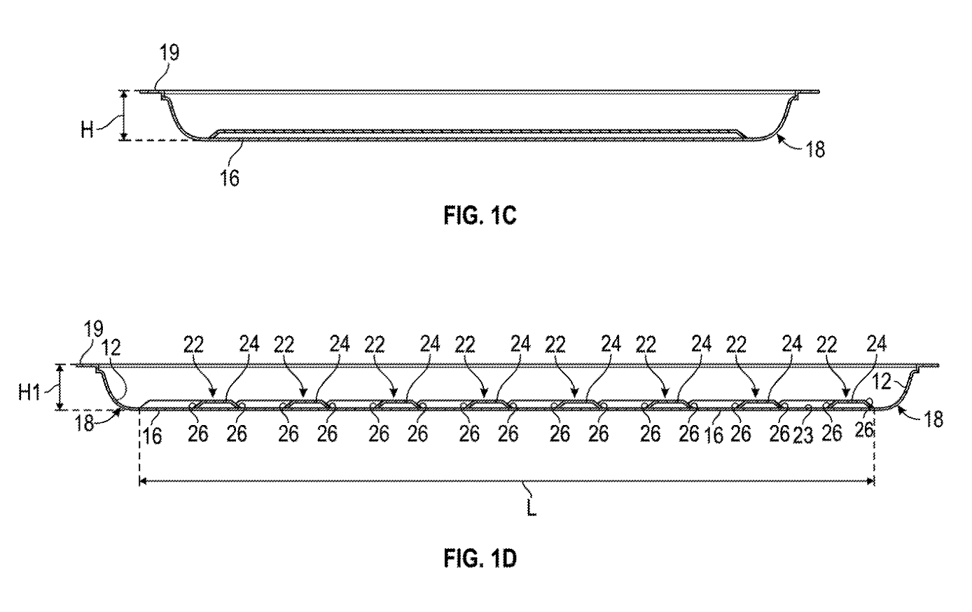

FIGS. 1A through 1D show a first embodiment of the heating construct according to one aspect of the disclosure with the construct or tray 10 including a bottom wall 16 having a lower surface 23 surrounded by a substantially continuous upstanding wall comprising end walls 12 on opposite ends and upstanding side walls 14 on opposite sides. The end walls 12 and side walls 14 are connected at respective corners 15, with four corners being shown in FIGS. 1A and 1B. In one embodiment, the tray 10 has a flange 19 forming an upper surface of the tray 10 that extends around the perimeter of the tray and extends laterally from the end walls 12, side walls 14, and corners 15. The tray 10 includes a bottom corner 18 that extends around the perimeter of the container at the transitions between the bottom wall 16 and the end walls 12, the transitions between the bottom wall 16 and side walls 14, and the transitions between the bottom wall 16 and the corners 15. In the illustrated embodiment, the tray 10 is generally rectangular with the end walls 12 extending between the side walls 14 and the generally rounded corners 15 connecting respective end walls and side walls, but the tray 10 could be otherwise shaped, arranged, and/or configured and could be other shapes (e.g., round, square, etc.) without departing from the disclosure.

As shown in specific in FIGS. 1A and 1B, tray 10 includes a pattern of supports 22 formed in the bottom wall 16. In one embodiment, the supports 22 extend upwardly from the bottom surface 23 in the interior of the tray 10. As shown in FIGS. 1A and 1B, the supports 22 are generally curved or wave-shaped along their length, but the supports could be other shapes (e.g., straight, orthogonal, etc.) without departing from the disclosure. In one embodiment, the tray 10 includes eight supports 22, but the tray could include more than eight or fewer than eight supports without departing from the disclosure.

The supports 22 have an upper surface 24 that is spaced apart and above the bottom surface 23 of the bottom wall. In one embodiment, the each support 22 includes two inclined side surfaces 26, each inclined side surface being on a respective side of the support and extending upwardly from the bottom surface 23 to the upper surface 24. In one embodiment, each inclined side surface 26 extends upwardly from the bottom surface 23 and is oblique relative to the bottom surface (e.g., positioned at an angle less than 90 degrees and greater than zero degrees relative to the bottom surface), but the inclined side surfaces could be orthogonal to the upper surface 24 or bottom surface 23, or otherwise shaped without departing from the disclosure. As shown in FIGS. 1A and 1B, each support 22 includes two inclined end surfaces 28, 30 that connect each of the inclined side surfaces at the respective ends of the support. The two inclined side surfaces 28, 30 extend upwardly from the bottom surface 23 at an angle less than 90 degrees, but the inclined end surfaces could be otherwise shaped, arranged, and/or configured without departing from the disclosure. The inclined end surfaces 28, 30 form respective rounded ends of the supports 22. The supports 22 could be otherwise shaped, arranged, and/or configured without departing from the disclosure.

In one exemplary embodiment, the tray 10 has a height H (FIG. 1C) extending from the bottom wall 16 to the top of the flange 19 of approximately 0.50 inches, the bottom wall 16 has a length L (FIG. 1D) of 8.10 inches and a width W (FIG. 1A) of 5.55 inches, the top surfaces 23 of the supports 22 are raised a height H2 (FIG. 1D) of 0.12 inches above the bottom wall 16.

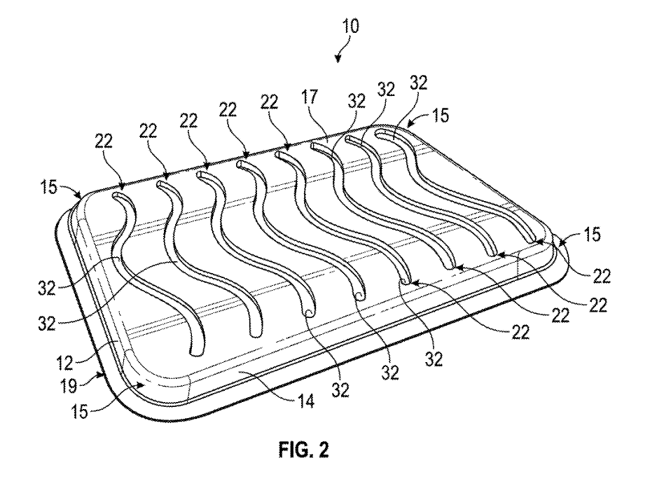

FIG. 2 shows a bottom view of the heating construct 10 with a lower exterior surface 17 opposite the interior surface 23 of the bottom wall 16. As shown in FIG. 2, the supports 22 are press formed in the bottom wall 16 so that the supports extend into the interior of the construct and form recesses 32 in the exterior surface 17 of the construct. The supports 22 could be formed by other forming techniques and could have other shapes without departing from the disclosure.

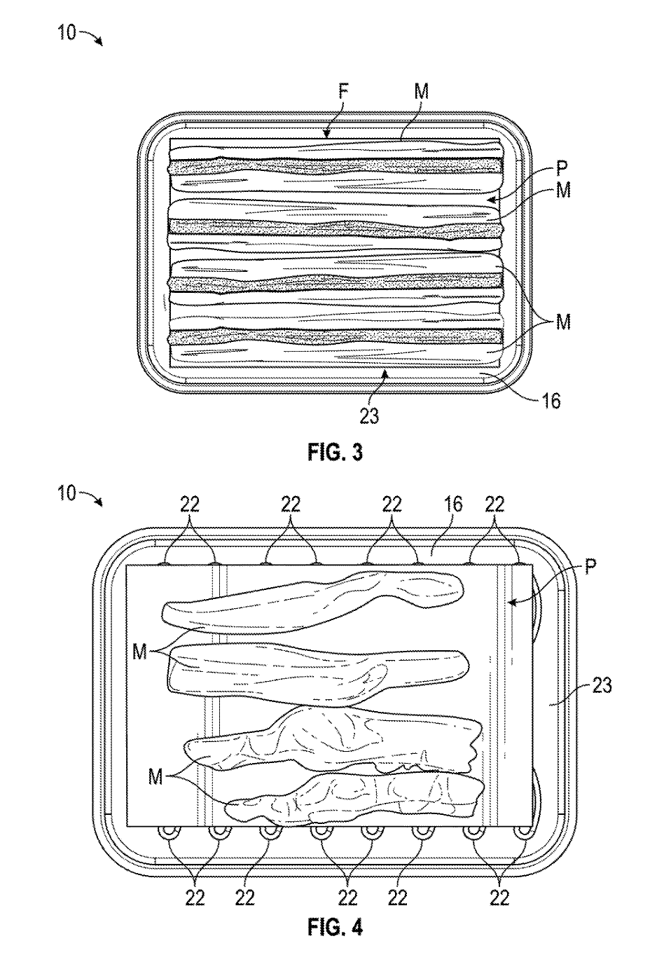

FIG. 3 shows an exemplary embodiment featuring the construct 10 shown in FIGS. 1A through 1D. In FIG. 3, the construct 10 is provided with a pad P, such as a polyester absorbent pad which is placed upon the supports 22. Above the pad P, a meat product M, such as bacon, is placed. The package including the construct 10, pad P, and meat product M, are then enclosed in a film F, such as a heavy duty gauge film to form the package shown in FIG. 3. In general, the absorbent pad P is sized to fit in the center area of the tray 10 and a specified number of meat products M is placed on the pad P before the film F is formed into a pouch. The entire package is then typically vacuum packed and heat sealed closed to form the package shown in FIG. 3.

FIG. 4 shows the heating construct 10 of FIG. 3 after heating and with the covering or film F removed. As shown in FIG. 4, the product P has been cooked.

In one example, the heating is performed in a microwave with a power of 1,100 W and at a cook time of two and one-half minutes. Optionally, the film can be vented prior to heating, as venting, generally, will improve the overall consistent cook throughout the individual product slices and will assist in not allowing the tray to warp or the film to be hyperinflated due to a post cook venting. Additionally, venting can provide the product to be heated to shrink less than in unvented packages, and less moisture generally will be retained in the film pouch due to venting.

Additional advantages of the raised supports 22 of the construct 10 are that the supports offer an elevated cooking platform for the product, enhances the grease mitigation pattern with the grease generally moving below the raised surface of the supports 22, and enhances the rigidity and stability of the tray during cooking by not allowing the tray to warp or deform. In another alternative to venting, the corner of the film can be torn or the plastic film can be separated. As to the pad, an additional benefit is that because the pad allows for much more grease absorption from the product, the entire package can withstand higher temperatures.

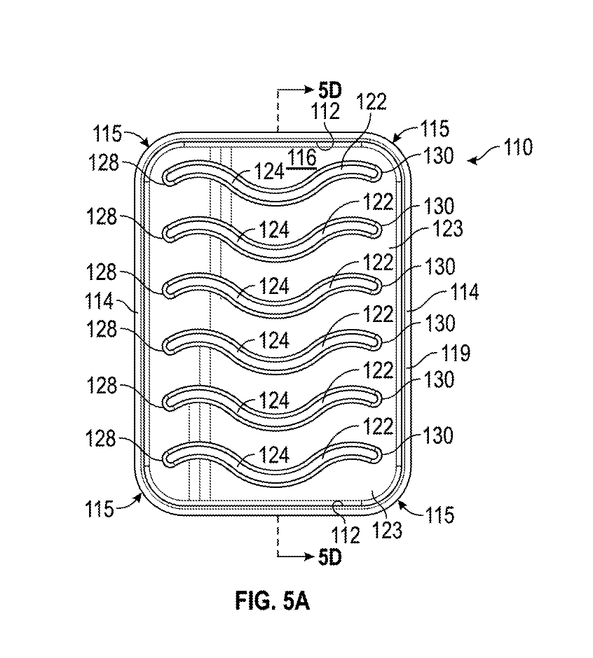

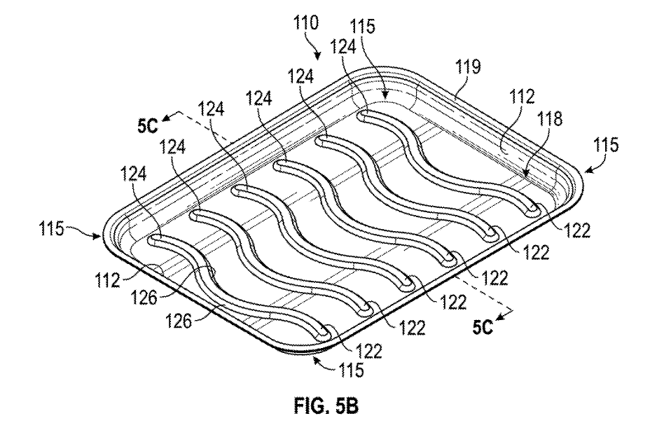

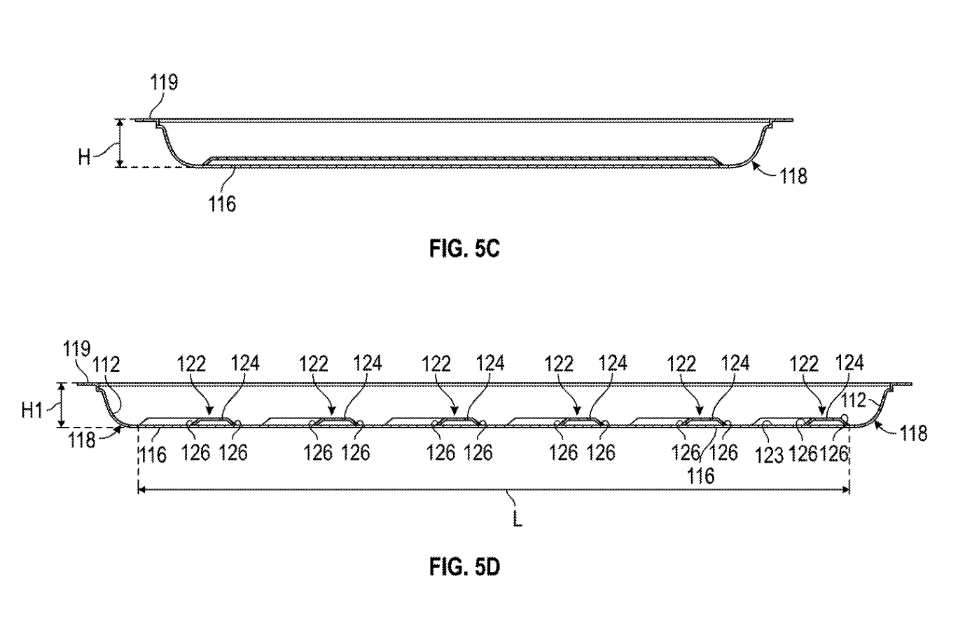

FIGS. 5A through 5D show a second embodiment of a heating construct according to one aspect of the disclosure. The tray or construct 110 shown in FIGS. 5A to 5D is substantially similar in several aspects to the tray 10 shown in FIGS. 1A to 1D. However, the number of supports shown in FIGS. 5A to 5D is different than shown in FIGS. 1A to 1D. The tray 110 shown in FIGS. 5A to 5D includes a bottom wall 116 surrounded by a substantially continuous upstanding wall comprising end walls 112 and side walls 114 connected at corners 115. In one embodiment, the tray 110 has a flange 119 forming an upper surface of the tray 110 that extends around the perimeter of the tray and extends laterally from the end walls 112, side walls 114, and corners 115. The tray 110 includes a bottom corner 118 that extends around the perimeter of the container at the transitions between the bottom wall 116 and the end walls 112, the transitions between the bottom wall 116 and side walls 114, and the transitions between the bottom wall 116 and the corners 115. In the illustrated embodiment, the tray 110 is generally rectangular with the end walls 112 extending between the side walls 114 and the generally rounded corners 115 connecting respective end walls and side walls, but the tray 110 could be otherwise shaped, arranged, and/or configured and could be other shapes (e.g., round, square, etc.) without departing from the disclosure.

As shown in specific in FIGS. 5A and 5B, tray 110 includes a pattern of supports 122 formed in the bottom wall 116. In one embodiment, the supports 122 can extend upwardly from the bottom surface 123 to an upper surface 124 that is raised above the bottom 116 along inclined surfaces 126. The supports 122 include two inclined end surfaces 128 and 130. As shown in FIGS. 5C and 5D, the supports are elevated above the bottom wall 116. Other aspects of the embodiment shown in FIGS. 5A-5D are similar to the embodiment of FIGS. 1A-1D. In one exemplary embodiment, the tray 110 has a height of 0.50 inches, the tray 110 has a width of 7.00 inches and a length of 9.50 inches, the designs are spaced 0.33 inches from the descent 118 of side walls 114, the descent 118 recedes at a 15° angle, and the perimeter of the upper surface had a width of 0.03 inches.

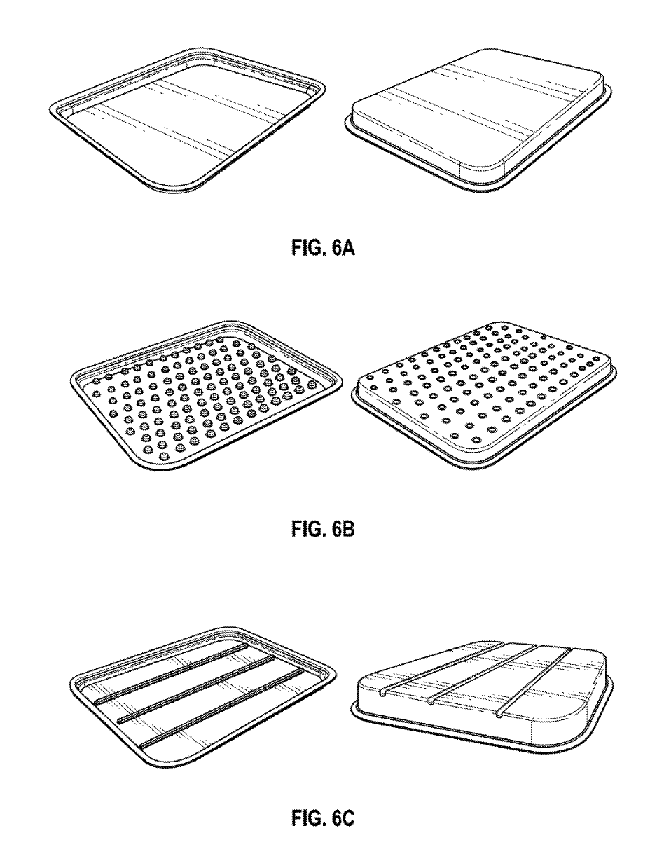

In contrast to the wave design as discussed in the exemplary embodiment above, FIGS. 6A, 6B, and 6C show alternative tray designs. FIG. 6A shows a first alternative embodiment tray design that does not include embossing or a pattern. FIG. 6B shows a second alternative embodiment tray design that includes raised hills or dots. FIG. 6C shows a third alternative embodiment tray design that includes raised lines that form sections for individual product slices.

In contrast to the exemplary embodiment discussed above with reference to FIGS. 1A to 1D, the flat tray design of FIG. 6A provided an inconsistent cook with each product P and in general did not perform as well as the raised wave designs 22 in the embodiment discussed above. While the tray with raised hills or dots shown in FIG. 6B allowed for excess grease to pool on the tray bottom, the raised hill or dot design also performed inferior to the exemplary embodiment shown in FIGS. 1A to 1D. The dot tray provided an inconsistent cook with each product slice. Although the raised lines section shown in FIG. 6C allowed the individual product slices to be positioned between the raised lines and provided some heat sealing between the product pieces, in contrast to the exemplary embodiment discussed above with FIGS. 1A to 1D, the sections tray shown in FIG. 6C did not fit the product well because of the compartments due to the natural variability of the product involved, here bacon. The section tray did not perform as well during heating with the inner strips and outer strips varying in degree of heating.

One embodiment of the present disclosure was tested with four strips of bacon placed on blotter paper resting on a tray in a vacuum sealed overwrap film and cooked in an 1100W microwave for slightly under three minutes. The bacon lost little volume, had an even overall crispy cook, and showed successful grease displacement.

Some aspects of the present disclosure include:

Tray or Paperboard Disc—The tray or paperboard is typically, though optionally, embossed to aid in additional grease mitigation after the grease and salt has passed through the wicking medium. The embossing is pressed in such a way that the grease will be distributed so as to cook the bacon evenly and simulate pan frying in the latter stages of the microwave cook. The embossing will also help act as a foundation for when the bacon product is firmly vacuum sealed inside the tray, allowing the bacon to maintain shape. This tray can also be thrown away with grease and wicking medium inside to save time and clean up effort.

In one embodiment, the tray comprises a single layer of paperboard that is press-formed to the desired shape. The tray can comprise more than one layer of paperboard, with additional layers enhancing enhance rigidity of the tray (e.g., polymer layers) and/or increasing the moisture/grease resistance of the paperboard. The multi-layered tray could be formed as a laminate of the multiple layers or any suitable process. The tray could comprise paperboard having a coating (e.g., polymer) that increases rigidity of the tray and/or increases the moisture/grease resistance of the tray.

Wicking Medium—The bacon product generally sits on an absorbent medium that allows permeation of bacon grease and salt. The grease evenly distributes across the medium from areas of higher concentration to areas of lower concentration. Once fully soaked, this wicking medium exhibits qualities similar to a susceptor by absorbing microwave energy and converting it into heat energy, essentially cooking the bacon evenly from the bottom in a method similar to pan frying.

Heat Sealable Film—The tray with wicking medium and bacon product inside generally is surrounded by heat sealed film and is vacuum packed. This film generally is thicker and heavier than conventional film so as not to rise and pop during cooking from steam and pressure. The film may also be heat sealed between bacon strips for additional direct contact. These features allow for essentially constant pressure on the bacon strips during cooking inhibiting curling and excessive volume loss.

According to common practice, the various features of the drawings discussed below are not necessarily drawn to scale. Dimensions of various features and elements in the drawings may be expanded or reduced to more clearly illustrate the embodiments of the disclosure.

In accordance with exemplary embodiments, the packaging material can be incorporated into blanks for forming respective constructs (e.g., trays, cartons, fast food containers, etc.). In such embodiments, the substrate can be formed from paperboard, corrugated cardboard or other materials having properties suitable for at least generally enabling respective functionalities described above. Paperboard can be of a caliper such that it is heavier and more rigid than ordinary paper, and corrugated cardboard can be of a caliper such that it is heavier and more rigid than paperboard. Generally, at least the side of the paperboard or cardboard that will be an exterior surface in the construct erected therefrom will be coated with a clay coating, or the like. The clay coating can be printed over with product, advertising, price-coding, and other information or images. The blanks may then be coated with a varnish to protect any information printed on the blanks. The blanks may also be coated with, for example, a moisture barrier layer, on one or both sides. The blanks can also be laminated to or coated with one or more sheet-like materials.

The foregoing description illustrates and describes various embodiments of the disclosure. As various changes could be made in the above construction, it is intended that all matter contained in the above description or shown in the accompanying drawings shall be interpreted as illustrative and not in a limiting sense. Furthermore, various modifications, combinations, and alterations, etc., of the above-described embodiments are within the scope of the disclosure. Additionally, the disclosure shows and describes only selected embodiments, but various other combinations, modifications, and environments are within the scope of the disclosure, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A tray for heating a food product, the tray comprising:
a plurality of walls that form an interior space of the tray, the plurality of walls comprises a bottom wall having a bottom surface at least partially defining the interior space, at least one side wall extending upwardly from the bottom wall, and at least one end wall extending upwardly from the bottom wall; and
at least one support formed in the bottom wall for supporting the food product in the interior space, the support comprising a raised surface that is spaced apart from the bottom surface.

2. The tray of claim 1, wherein the at least one support comprises at least one side surface that extends from the bottom wall to the raised surface.

3. The tray of claim 3, wherein the at least one side surface is oblique relative to the bottom surface.

4. The tray of claim 3, wherein the support comprises two side surfaces and a first end surface connecting the two side surfaces at a first end of the support and a second end surface connecting the two side surfaces at a second end of the support.

5. The tray of claim 1, wherein the at least one support comprises a plurality of supports.

6. The tray of claim 5, wherein each support of the plurality of supports is curved along a length of the support.

7. The tray of claim 6, wherein the bottom panel comprises a plurality of recesses in the bottom panel, the plurality of recesses being formed in the exterior surface of the construct.

8. The tray of claim 7, wherein the plurality of recesses correspond to the shape of the plurality of supports.

9. The tray of claim 5, wherein each support of the plurality of supports is straight along a length of the support.

10. The tray of claim 5, wherein each support of the plurality of supports is a raised hill.

11. The tray of claim 1, wherein the at least one side wall comprises a first side wall and a second side wall, the at least one end wall comprises a first end wall and a second end wall, the tray comprises a plurality of corner, each corner of the plurality of corners connecting a respective adjacent first end wall and second end wall with respective adjacent first side wall and second side wall.

12. The tray of claim 11, further comprising a flange extending laterally outward from the first side wall, second side wall, first end wall, second end wall, and the plurality of corners, the flange forming an upper surface of the tray and extending around the perimeter of the tray.

13. The tray of claim 12, further comprising a bottom corner that extends around the perimeter of the tray, the bottom corner is curved and connects bottom wall with the first side wall, the second side wall, the first end wall, the second end wall, and the plurality of corners.

14. The tray of claim 1, in combination with a food product and an absorbent pad, the absorbent pad being placed between the food product and the at least one support.

15. A method of heating a food product, the method comprising:
obtaining a package comprising a tray having
a plurality of walls that form an interior space of the tray, the plurality of walls comprises a bottom wall having a bottom surface at least partially defining the interior space, at least one side wall extending upwardly from the bottom wall, and at least one end wall extending upwardly from the bottom wall, and
at least one support formed in the bottom wall for supporting the food product in the interior space, the support comprising a raised surface that is spaced apart from the bottom surface, and
a food product supported on the supports in the interior space of the tray; heating the package by exposing the package to microwave energy.

16. The method of claim 15, wherein the package further comprises an absorbent pad between the at least one support and the food product in the interior space of the tray.

17. The method of claim 16, wherein the absorbent pad at least partially absorbs grease from the food product during heating.

18. The method of claim 17, wherein the package further includes a film surrounding the tray and enclosing the interior space of the tray.

19. The method of claim 18, further comprises forming a vent opening in the film prior to the heating.

20. The method of claim 15, further comprising an absorbent pad between the food product and the at least one support.
